(19) United States
(12) Patent Application Publication
(10) Pub. No.: US 2012/0251047 A1
(43) Pub. Date: Oct. 4, 2012

(54) MACH-ZEHNDER INTERFEROMETER-ARRAYED WAVEGUIDE GRATING AND PLANAR LIGHT-WAVE CIRCUIT CHIP

(75) Inventor: Kazutaka NARA, TOKYO (JP)

(73) Assignee: FURUKAWA ELECTRIC CO., LTD., TOKYO (JP)

(21) Appl. No.: 13/448,967

(22) Filed: Apr. 17, 2012

Related U.S. Application Data
(63) Continuation of application No. PCT/JP11/69174, filed on Aug. 25, 2011.

(30) Foreign Application Priority Data
Aug. 27, 2010 (JP) 2010-190637

(51) Int. Cl. G02B 6/34

(52) U.S. Cl. 385/37

(57) ABSTRACT

The present invention provides a Mach-Zehnder interferometer-arrayed waveguide grating (MZI-AWG) and a planar light-wave circuit chip in which a certain number of chips can be secured without degradation of MZI-AWG characteristics. An MZI-AWG (10) includes a Mach-Zehnder interferometer (MZI) (20) and an arrayed waveguide grating (AWG) (30) using the MZI for an input waveguide. The FSR of the MZI and the channel spacing of the AWG coincide with each other. An input side coupler (21) and an output side coupler (22) of the MZI are disposed on a straight line connecting a center part (a₀) in one end surface (31a) of an input slab waveguide (31) and a center part (b₀) in the other end surface (31b) which is a circular-arc shaped end surface having a radius of a focal length (Lf) from the center part (a₀).

### CROSS-REFERENCES TO RELATED APPLICATIONS

This application is a continuation application of International Application No. PCT/JP2011/069174, filed Aug. 25, 2011, which claims the benefit of Japanese Patent Application No. 2010-190637, filed Aug. 27, 2010. The contents of the aforementioned applications are incorporated herein by reference in their entireties.

### TECHNICAL FIELD

The present invention relates to a Mach-Zehnder interferometer-arrayed waveguide grating using an asymmetric Mach-Zehnder interferometer for an input waveguide, and relates to a planar light-wave circuit chip.

### BACKGROUND ART

Conventionally, there has been known a Mach-Zehnder interferometer-arrayed waveguide grating (MZI-AWG) using, for an input waveguide, a Mach-Zehnder interferometer which has an optical path length difference between two arm waveguides (refer to Patent document 1). This MZI-AWG 100 is shown in FIG. 7. The MZI-AWG 100 includes a Mach-Zehnder interferometer (MZI) 102 and an arrayed waveguide grating (AWG) 104 using the MZI 102 for an input waveguide. For this MZI-AWG 100, the number of chips obtained from a wafer is increased by a layout of using a cross waveguide in which two arm waveguides 110 and 110′ intersect each other at a crossing part 112 and inverting the two arm waveguides 110 and 110′ of the MZI 102.

### PRIOR ART TECHNICAL DOCUMENT

### [Patent Document]

[Patent document 1] EP Publication No. 1857846

### SUMMARY OF INVENTION

In the above conventional art, however, loss is caused at the crossing part 112, and further there is a possibility that radiation light generated at the crossing part 112 becomes stray light and leads to degradation of MZI-AWG characteristics. In particular, the loss (diffraction loss) caused at the crossing part 112 increases as a relative refractive index difference Δ is reduced for further miniaturization of the planar light-wave circuit. Further, since the loss is caused when a crossing angle θ at the crossing part 112 is small, it is preferable to make the crossing angle θ larger than approximately 60 degrees. When the crossing angle θ is increased, however, a formation area of the arm waveguides 110 and 110′ becomes larger and it becomes difficult to miniaturize the planar light-wave circuit.

The present invention has been achieved in view of such a conventional problem, and aims at providing a Mach-Zehnder interferometer-arrayed waveguide grating and a planar light-wave circuit chip in which a certain number of chips can be secured without degradation of the MZI-AWG characteristics.

For solving the above problem, an invention according to a first aspect of the present invention is a Mach-Zehnder interferometer-arrayed waveguide grating comprising: a Mach-Zehnder interferometer including an input waveguide, an input side coupler connected to the input waveguide, an output side coupler, and two arm waveguides connected between the input side coupler and the output side coupler so as to have an optical path length difference; and an arrayed waveguide grating including an input slab waveguide connected with the output side coupler of the Mach-Zehnder interferometer, a plurality of output waveguides, an output slab waveguide connected with the output waveguides, and an arrayed waveguide having a plurality of channel waveguides connected between the input slab waveguide and the output slab waveguide, wherein: a free spectral range of the Mach-Zehnder interferometer and a channel spacing of the arrayed waveguide grating are configured so as to coincide with each other; the arm waveguide having a longer optical path length of the two arm waveguides in the Mach-Zehnder interferometer is disposed on the same side as the channel waveguide having a longer optical path length in the arrayed waveguide; and the input side coupler is disposed on a straight line connecting a center part of one end surface of the input slab waveguide and the output side coupler, the one end surface having the arrayed waveguide formed thereon.

An invention according to a second aspect of the present invention is a planar light-wave circuit chip including the Mach-Zehnder interferometer-arrayed waveguide grating according to the above first aspect and has a boomerang shape comprising: a bent central part including the arrayed waveguide; a first straight part extending from one end of the central part and including the input slab waveguide; a second straight part extending from the other end of the central part so as to form an angle with the first straight part and including the output slab waveguide; a first side end part extending from the first straight part and including the Mach-Zehnder interferometer; and a second side end part extending from the second straight part and including the plurality of output waveguides.

According to the present invention, the input side coupler and the output side coupler of the Mach-Zehnder interferometer are disposed on an extension line of a radius of the input slab waveguide from the center part in one end surface of the input slab waveguide where the arrayed waveguide is formed, and thereby a certain number of chips can be secured from a wafer without the degradation of the MZI-AWG characteristics.

The conventional art increases the number of chips obtained from a wafer by a layout of inverting the arm waveguide part of the Mach-Zehnder interferometer which serves as the input waveguide, using the cross waveguide, and thereby loss is caused in the cross waveguide and resultantly there is a possibility that the generated radiation light becomes stray light and leads to the degradation of the MZI-AWG characteristics. On the other hand, according to the present invention, the cross waveguide is not used for realizing a low-loss flat-type Mach-Zehnder interferometer-arrayed waveguide grating and thereby it is possible to secure a certain number of chips without the degradation of the MZI-AWG characteristics.

### BRIEF DESCRIPTION OF THE DRAWINGS

FIG. 1 is a plan view showing a schematic configuration of a Mach-Zehnder interferometer-arrayed waveguide grating according to a first embodiment of the present invention.

FIG. 2 is an explanatory diagram showing an enlarged part of the Mach-Zehnder interferometer-arrayed waveguide grating shown in FIG. 1

FIG. 3 is a plan view showing a part of a substrate (wafer) on which a plurality of Mach-Zehnder interferometer-arrayed waveguide gratings is formed.

FIG. 4 is a plan view showing one planar light-wave circuit chip cut out from the substrate shown in FIG. 3.

FIG. 5 is a plan view showing a schematic configuration of a Mach-Zehnder interferometer-arrayed waveguide grating according to a second embodiment of the present invention.

FIG. 6 is a plan view showing a schematic configuration of a Mach-Zehnder interferometer-arrayed waveguide grating according to a third embodiment of the present invention.

FIG. 7 is a plan view showing a schematic configuration of a conventional Mach-Zehnder interferometer-arrayed waveguide grating.

### DESCRIPTION OF EMBODIMENTS

In the following, each embodiment embodying the present invention will be explained according to the drawings. Note that similar parts are provided with the same reference numeral and overlapping explanation will be omitted in explanation of each embodiment.

### First Embodiment

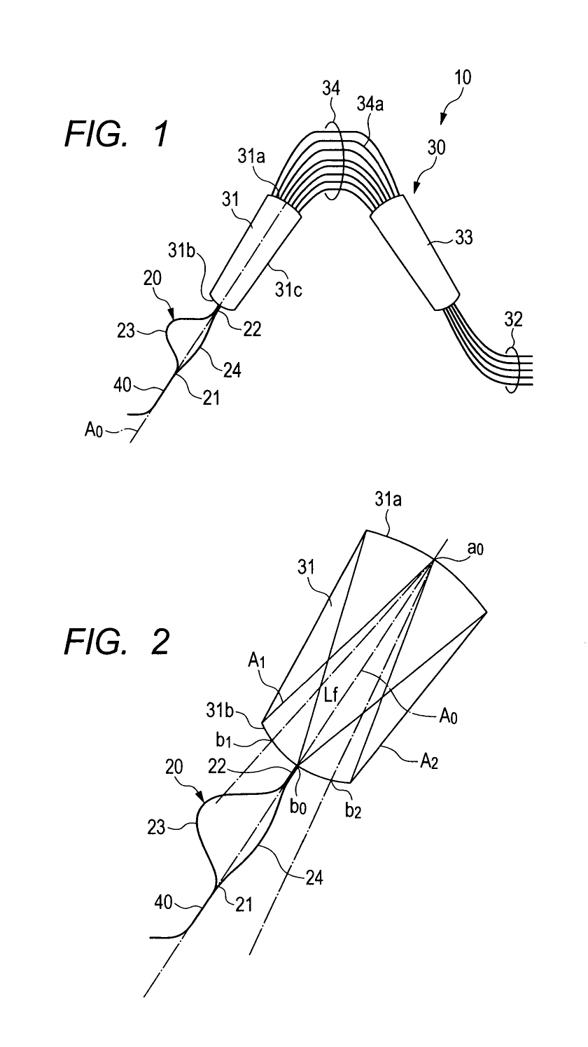

FIG. 1 shows a schematic configuration of a Mach-Zehnder interferometer-arrayed waveguide grating (hereinafter, called MZI-AWG) 10 according to a first embodiment of the present invention.

The MZI-AWG 10, as shown in FIG. 1, includes a Mach-Zehnder interferometer (hereinafter, called MZI) 20 and an arrayed waveguide grating (hereinafter, called AWG) 30 using the MZI 20 for an input waveguide. In this MZI-AWG 10, the free spectral range (FSR) of the MZI 20 and the channel spacing of the AWG 30 are caused to coincide with each other.

The MZI 20 is an asymmetric Mach-Zehnder interferometer including an input waveguide 40, an input side coupler 21 connected to the input waveguide 40, and two arm waveguides 23 and 24 having a predetermined optical path length difference ΔL and connected between the input side coupler 21 and an output side coupler 22. The predetermined optical path length difference ΔL is set to a value which causes the FSR of the MZI 20 to coincide with the channel spacing of the AWG 30.

Here, the input side coupler 21 is configured with a Y-branch element, for example, and the output side coupler 22 is configured with a 3-dB directional coupler, for example. The input side coupler 21 is connected with the input waveguide 40. The input side coupler 21 may be configured with a 3-dB directional coupler.

The AWG 30 includes an input slab waveguide 31 connected with the output side coupler 22 of the MZI 20, a plurality of output waveguides 32, an output slab waveguide 33 connected with the output waveguides 32, and an arrayed waveguide 34 configured with a plurality of channel waveguides 34a connected between the input slab waveguide 31 and the output slab waveguide 33. The plurality of channel waveguides 34a is disposed so as to cause an optical path length to be different by a constant value between the neighboring channel waveguides 34a.

Further, as shown in FIG. 1 and FIG. 2, of both end surfaces of the input slab waveguide 31, a circular-arc having a radius of a focal length Lf from a center part a₀ of one end surface 31a where the arrayed waveguide 34 is formed constitutes the other end surface 31b connected with the output side coupler 22 of the MZI 20.

The feature of this MZI-AWG 10 is the following configuration thereof as shown in FIG. 1 and FIG. 2.

(1) The arm waveguide 23 having a longer optical path length in the MZI 20 is positioned on the same side as the channel waveguide 34a having a longer optical path length in the arrayed waveguide 34.

(2) The input side coupler 21 and the output side coupler 22 in the MZI 20 are disposed on an extension line of the radius (radius of the focal length Lf) of the input slab waveguide 31 from the center part a₀ in the one end surface 31a of the input slab waveguide 31 where the arrayed waveguide 34 is formed.

That is, the input side coupler 21 and the output side coupler 22 are disposed on an extension line of a straight line connecting the center part a₀ of the one end surface 31a where the arrayed waveguide 34 is formed, of the both end surfaces of the input slab waveguide 31, and a point positioned apart from the center part a₀ by the radius of the input slab waveguide 31.

In the present embodiment, for example, the input side coupler 21 and the output side coupler 22 of the MZI 20 are disposed on an extension line A₀ of a straight line connecting the center part a₀ in the one end surface 31a of the input slab waveguide 31 and a center part b₀ in the other end surface 31b which is the circular-arc shaped end surface having a radius of the focal length Lf from this center part a₀.

(3) The output side coupler 22 of the MZI 20 is connected to the other end surface 31b of the input slab waveguide 31.

In the present embodiment, the output side coupler 22 is connected to the input slab waveguide at the center part b₀ of the other end surface 31b.

Specifically, two output ends of the output side coupler 22 which is configured with the 3-dB directional coupler are connected to the input slab waveguide 31 at positions symmetrical to each other about the center part b₀.

In this manner, in the MZI-AWG 10, the MZI 20, in which the arm waveguides 23 and 24 are configured to have an optical path length difference ΔL, is used for an input waveguide of the AWG 30, the FSR of the MZI 20 and the channel spacing of the AWG 30 are caused to coincide with each other, and the arm waveguide 23 having a longer optical path length in the MZI 20 is laid out to be positioned on the same side as the channel waveguide 34a having a longer optical path length in the arrayed waveguide 34. Then, the input side coupler 21 and the output side coupler 22 of the MZI 20 are disposed on an extension line of the radius of the focal length Lf in the input slab waveguide 31 from the center part a₀ in the one end surface 31a of the input slab waveguide 31.

The MZI-AWG 10 having the above configuration, as same as a typical AWG, can perform a wavelength separation function of taking out a desired wavelength from each of the output waveguides 32 and a wavelength multiplexing function causing light to travel the optical path reversely.

In the MZI-AWG 10, when light multiplexing a plurality of wavelengths (X1 to X11) enters the input waveguide 40 of the MZI 20, in a light input part (light incidence surface) of the input slab waveguide 31 in the AWG 30, the position of the photoelectric field distribution changes depending on the wavelength in a predetermined wavelength region of each channel, at a period of the FSR in the MZI 20, according to a wavelength characteristic of the MZI 20 in which the channel spacing of the AWG 30 and the FSR are caused to coincide with each other.

On the other side, in a light output part (light collection part) of the output slab waveguide 33 in the AWG 30, light collection position is different depending on the wavelength in the predetermined wavelength region of each channel.

Such light collection position movement depending on the wavelength in the light collection surface of the output slab waveguide 33 is cancelled by means of causing the position of the photoelectric field distribution (optical field) to change at a period of the FSR according to the wavelength characteristic of the MZI 20 depending on the wavelength in the light input surface of the input slab waveguide 31.

By such a configuration, the optical field movement depending on the wavelength in the predetermined wavelength region of each channel is stopped apparently in the light collection surface of the output slab waveguide 33 and flattening is performed.

According to the MZI-AWG 10 having the above configuration, the following function and effect are realized.

It is possible to realize an MZI-AWG having a low-loss and flat transmission spectrum characteristic in the predetermined band in each channel by stopping the movement of the photoelectric field distribution against optical frequency change around a center optical frequency in each channel.

The output side coupler 22 of the MZI 20 is connected to the input slab waveguide 31 at a point positioned apart from the center part a₀ in the one end surface 31a of the input slab waveguide 31 (center part b₀ of the other end surface 31b which is a circular-arc shaped end surface) by a distance of the focal length Lf. Accordingly, differently from the conventional art using the cross waveguide, the loss is not caused at the crossing part 112 or there is not a possibility that the radiation light generated at the crossing part 112 becomes stray light and leads to the degradation of the MZI-AWG characteristics.

Further, since the cross waveguide is not used, it becomes easy to reduce the relative refractive index difference Δ and to miniaturize the planar light-wave circuit.

Further, the input side coupler 21 and the output side coupler 22 of the MZI 20 are disposed on the extension line A₀ of a straight line connecting the center part a₀ in the one end surface 31a of the input slab waveguide 31 and the center part b₀ in the other end surface 31b which is a circular-arc shaped end surface having a radius of the focal length Lf from this center part a₀. By this configuration, part of the MZI 20 (parts of the arm waveguides 23 and 24 and input side coupler 21) and the input waveguide 40 connected to the coupler 21 do not protrude inside (to the right side in FIG. 1) from the inner side surface 31c of the input slab waveguide 31.

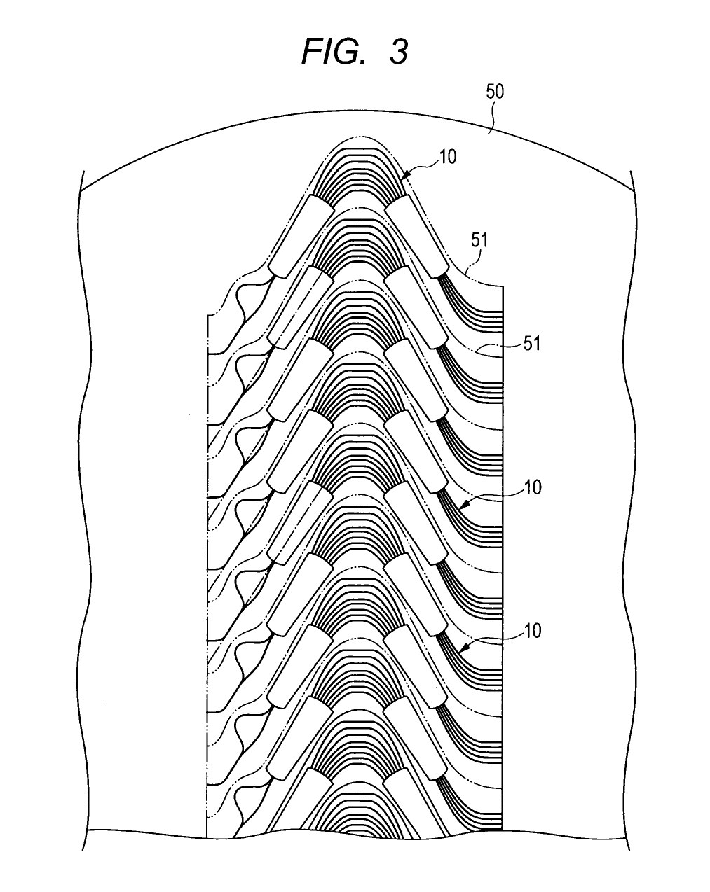

Thereby, as shown in FIG. 3, a certain number of the MZI-AWGs 10 can be secured when the plurality of MZI-AWGs 10 is formed on one wafer (e.g., wafer such as a silicon substrate having a diameter of four inches) 50 close to each other so as to cause the neighboring MZI-AWGs 10 not to cross each other.

Further, it is possible to further increase the number of MZI-AWGs 10 obtained from one wafer by reducing relative refractive index difference Δ and reducing the size of the MZI-AWG itself. On the other hand, in the above conventional art, when the relative refractive index difference Δ is reduced for reducing the size of the MZI-AWG circuit itself, diffraction loss is increased at the above crossing part 112 (refer to FIG. 7) and thus it is necessary to increase the crossing angle θ. Thereby, the MZI-AWG circuit itself becomes larger and the number of the MZI-AWG circuits obtained from one wafer is reduced.

In this manner, according to the MZI-AWG 10 of the present embodiment, a certain number of chips can be secured without the degradation of the MZI-AWG characteristics.

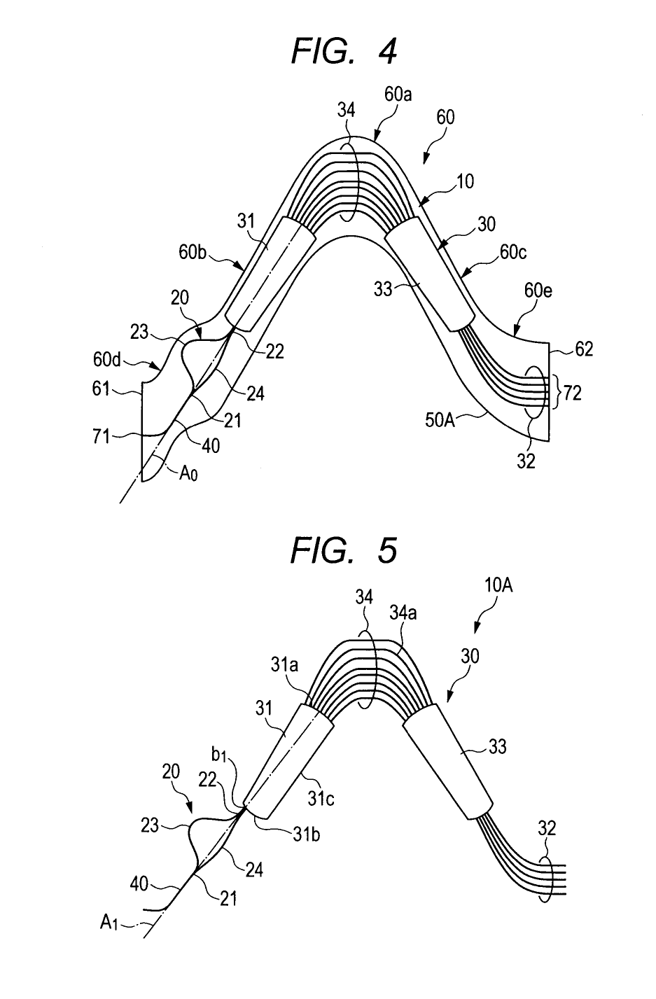

FIG. 4 shows one planar light-wave circuit chip (hereinafter, called PLC chip) 60 cut out from the wafer 50 shown in FIG. 3. In FIG. 3, reference numeral “51” indicates a cut line by a laser such as a carbon dioxide laser when the individual PLC chips 60 are cut out from the wafer 50.

In the PLC chip 60 shown in FIG. 4, the MZI-AWG (MZI-AWG circuit) 10 shown in FIG. 1 is formed on a substrate 50A.

The PLC chip 60 including the MZI-AWG 10 is cut out along the cut line 51 by a laser from one wafer 50 on which the plurality of MZI-AWGs 10 is formed close to each other so as not to cross each other as shown in FIG. 3.

The outline of one PLC chip 60 cut out from one wafer 50 in this manner has a boomerang shape including the following configurations (a) to (d).

(a) Having a bent central part 60a where the arrayed waveguide 34 is formed

(b) Having right and left straight parts 60b and 60c which extend from both sides of the central part 60a so as to form an angle with each other and in which the input slab waveguide 31 and the output slab waveguide 33 are formed, respectively

(c) Having a left side end part 60d where the MZI 20 is formed

(d) Having a right side end part 60e where the plurality of output waveguides 32 is formed.

Further, in the left side end part 60d, a straight-line shaped input side end surface 61 is formed including an input port 71 which is an end part of the input waveguide 40. In the right side end part 60e, a straight-line shaped output side end surface 62 is formed including an output port which is each an end part of the plurality of output waveguides 32. The input side end surface and the output side end surface 62 are approximately parallel to each other.

The PLC chip 60 shown in FIG. 4 is fabricated as follows.

First, as shown in FIG. 3, on the wafer 50 such as a quartz substrate or a silicon substrate, the plurality of MZI-AWGs 10 each including an optical waveguide having a core and a cladding is formed by the use of a combination of the optical fiber manufacturing technique and the semiconductor microfabrication technique.

Next, the wafer 50 shown in FIG. 3 is cut along the cut line 51 and thereby the plurality of PLC chips 60 is fabricated.

In this manner, in the PLC chip 60 including the MZI-AWG 10 and having a whole outline of the boomerang shape, it is possible to realize miniaturization and also to reduce manufacturing cost.

Further, since the input side end surface 61 and the output side end surface 62 each having a straight-line shape are provided in the PLC chip 60, it is easy to perform connection with an optical fiber which serves as a transmission line of signal light, another PLC chip having an optical waveguide based on silica-based material, and an active optical component such as a semiconductor laser element and a semiconductor light-receiving element.

### EXAMPLE

As an example, a PLC chip 60 including an MZI-AWG 10 having a channel spacing of 100 GHz and the number of channels of 40 ch was fabricated by the use of a silica-based PLC having a relative refraction index difference Δ of 1.2%.

Further, with respect to the number of the PLC chips 60 fabricated from one wafer 50, the following result was obtained.

In the case in which an MZI-AWG having a channel spacing of 100 GHz and the number of channels of 40 ch was fabricated by the use of a silica-based PLC having a relative refraction index difference Δ of 1.2%, ten PLC chips 60 were able to be fabricated from one 4-inch wafer according to the present embodiment. On the other hand, in the case of using the above conventional art, the number of the PLC chips fabricated from one 4-inch wafer was four.

### Second Embodiment

FIG. 5 shows a schematic configuration of an MZI-AWG 10A according to a second embodiment of the present invention. In this MZI-AWG 10A, as shown in FIG. 2 and FIG. 5, the two couplers 21 and 22 of the MZI 20 are disposed on an extension line A₁ of a straight line connecting the center part a₀ in the one end surface 31a of the input slab waveguide 31 and a point b₁ shifted leftward from the center part b₀ in the other end surface (circular-arc shaped end surface) 31b (point positioned apart from the center part a₀ by the focal length Lf). The other configuration of the MZI-AWG 10A is the same as that of the MZI-AWG 10 shown in FIG. 1.

### Third Embodiment

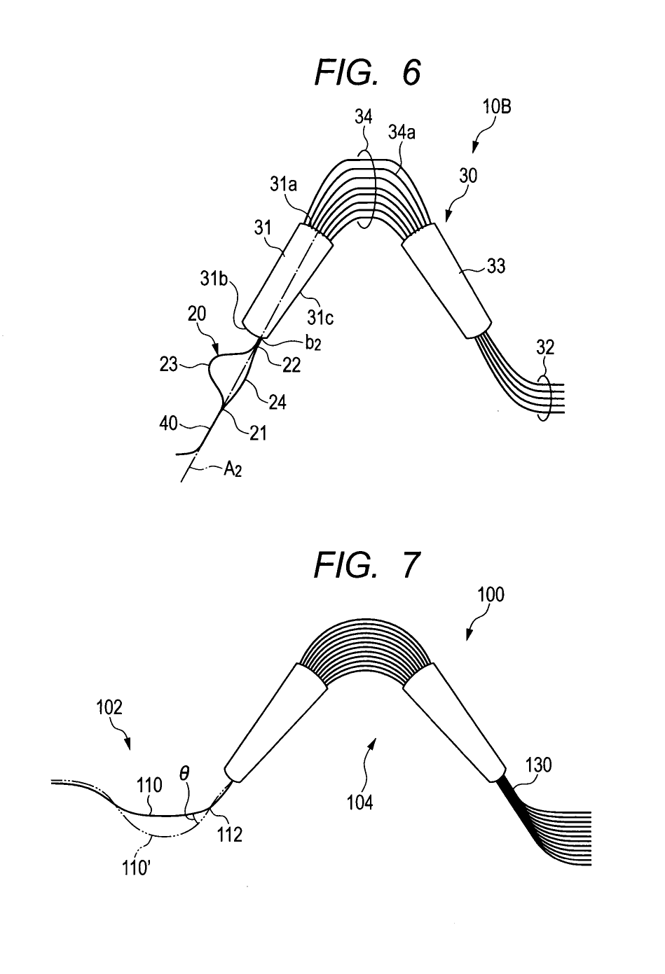

FIG. 6 shows a schematic configuration of an MZI-AWG 10B according to a third embodiment of the present invention. In this MZI-AWG 10B, as shown in FIG. 2 and FIG. 6, the two couplers 21 and 22 of the MZI 20 are disposed on an extension line A₂ of a straight line connecting the center part a₀ in the one end surface 31a of the input slab waveguide 31 and a point b₂ shifted rightward from the center part b₀ in the other end surface (circular-arc shaped end surface) 31b (point positioned apart from the center part a₀ by the focal length Lf). The other configuration of the MZI-AWG 10B is the same as that of the MZI-AWG 10 shown in FIG. 1.

Here, it is possible to correct a center wavelength by disposing the two couplers 21 and 22 of the MZI 20 on an extension line of a straight line connecting the center part a₀ in the one end surface 31a of the input slab waveguide 31 and the point b₁ or b₂ shifted from the center part b₀ in the other end surface (circular-arc shaped end surface) 31b as shown in the second embodiment and the third embodiment.

While, typically, as shown in the first embodiment, design is performed so as to set the center wavelength for the case that the two coupler and 22 of the MZI 20 are disposed on an extension line of a straight line connecting the center part a₀ in the one end surface 31a of the input slab waveguide 31 and the center part b₀ in the other end surface (circular-arc shaped end surface) 31b, there is a case in which the center wavelength of each chip becomes different according to process error distribution within the wafer or the like in manufacturing.

In such a case, it is possible correct the center wavelength optionally by disposing the couplers 21 and 22 on an extension line of a straight line connecting the center part a₀ in the one end surface 31a of the input slab waveguide 31 and the point b₁ or b₂ shifted from the center part b₀ in the other end surface (circular-arc shaped end surface) 31b and adjusting a shift amount form the center part b₀, as shown in the second embodiment and the third embodiment.

Note that this invention can be embodied by modification as follows.

The present invention is not limited to the configurations of the above first to third embodiments, and can be applied to a case in which the two couplers 21 and 22 of the MZI 20 are disposed on an extension line of a straight line connecting the center part a₀ in the one end surface 31a of the input slab waveguide 31 and a point positioned apart from this center part a₀ by the focal length Lf of the input slab waveguide 31.

For example, the present invention can be applied also to a case in which the two couplers 21 and 22 of the MZI 20 are disposed on an extension line of a straight line connecting the center part a₀ in the one end surface 31a of the input slab waveguide 31 and an optional point except the above points b₀, b₁, and b₂ on the other end surface 31b which is an circular-arc shaped end surface.

1. A Mach-Zehnder interferometer-arrayed waveguide grating comprising:
a Mach-Zehnder interferometer including an input waveguide, an input side coupler connected to the input waveguide, an output side coupler, and two arm waveguides having an optical path length difference and connected between the input side coupler and the output side coupler; and
an arrayed waveguide grating including an input slab waveguide connected with the output side coupler of the Mach-Zehnder interferometer, a plurality of output waveguides, an output slab waveguide connected with the output waveguides, and an arrayed waveguide having a plurality of channel waveguides and connected between the input slab waveguide and the output slab waveguide, wherein:
a free spectral range of the Mach-Zehnder interferometer and a channel spacing of the arrayed waveguide grating are configured so as to coincide with each other;
the arm waveguide having a longer optical path length of the two arm waveguides in the Mach-Zehnder interferometer is disposed on the same side as the channel waveguide having a longer optical path length in the arrayed waveguide; and
the input side coupler is disposed on a straight line connecting a center part of one end surface of the input slab waveguide and the output side coupler, the one end surface having the arrayed waveguide formed thereon.

2. The Mach-Zehnder interferometer-arrayed waveguide grating according to claim 1, wherein
the other end surface of the input slab waveguide is a circular-arc shaped end surface having a radius of a focal length from the center part of the one end surface, and the circular-arc shaped end surface is connected with the output side coupler of the Mach-Zehnder interferometer.

3. The Mach-Zehnder interferometer-arrayed waveguide grating according to claim 2, wherein
the output side coupler of the Mach-Zehnder interferometer is connected to the center part of the circular-arc shaped end surface.

4. The Mach-Zehnder interferometer-arrayed waveguide grating according to claim 2, wherein
the output side coupler of the Mach-Zehnder interferometer is connected to a position shifted from the center part of the circular-arc shaped end surface.

5. The Mach-Zehnder interferometer-arrayed waveguide grating according to claim 1, wherein
the output side coupler of the Mach-Zehnder interferometer is a 3-dB directional coupler.

6. A planar light-wave circuit chip which includes the Mach-Zehnder interferometer-arrayed waveguide grating according to claim 1, and has a boomerang shape comprising:
a bent central part including the arrayed waveguide;
a first straight part extending from one end of the central part and including the input slab waveguide;
a second straight part extending from the other end of the central part so as to form an angle with the first straight part and including the output slab waveguide;
a first side end part extending from the first straight part and including the Mach-Zehnder interferometer; and
a second side end part extending from the second straight part and including the plurality of output waveguides.

7. The planar light-wave circuit chip according to claim 6, wherein
the first side end part has a straight-line shaped input side end surface where an end part of the input waveguide connected to the input side coupler of the Mach-Zehnder interferometer exists, and also the second side end part has a straight-line shaped output side end surface where each end part of the plurality of output waveguides exists.
